(19) United States
(12) Patent Application Publication
(10) Pub. No.: US 2026/0278870 A1
(43) Pub. Date: Sep. 17, 2026

(54) ALIGNING AND DISTRIBUTING GRAPHICAL OBJECTS ACROSS VECTOR SPLINES

(71) Applicant: Adobe Inc., San Jose, CA (US)

(72) Inventors: Rishav Agarwal, Howrah (IN); Arushi Jain, Delhi (IN); Ankur Gupta, Noida (IN); Shashidhar Mangu, Ghatkesar (IN); Saurav Agrawal, Hyderebad (IN); Praveen Kumar Dhanuka, Howrah (IN)

(21) Appl. No.: 19/076,688

(22) Filed: Mar. 11, 2025

(51) Int. Cl. G06T 11/60; G06T 3/60; G06T 11/20

(52) U.S. Cl. CPC G06T 11/60; G06T 3/60; G06T 11/23

(57) ABSTRACT

The present disclosure relates to systems, non-transitory computer-readable media, and methods for aligning and distributing digital objects along vector splines within digital design document. For example, the disclosed systems generate an accumulated length repository comprising accumulated lengths of a plurality of curve segments along a vector spline. Based on a uniform distance for placing a plurality of design objects along the vector spline, the disclosed systems search the accumulated length repository to identify selected curve segments from the plurality of curve segments for placing the plurality of design objects and generate a plurality of placement locations along the selected curve segments based on the uniform distance. Accordingly, in some embodiments, the disclosed systems generate a modified digital design document by placing the plurality of design objects at the plurality of placement locations.

### BACKGROUND

Recent years have seen significant advancements in hardware and software platforms for creating and editing digital illustration documents. For example, many platforms provide software applications that contain tools to modify objects within digital illustration documents. To illustrate, in the field of digital image editing, many platforms provide computer-implemented tools or algorithms to help guide the creation, modification, and arrangement of graphical objects. Despite the advancements of conventional digital illustration systems that utilize these tools, however, these conventional systems continue to suffer from a number of disadvantages in relation to efficiency, accuracy, and operational flexibility.

### BRIEF SUMMARY

One or more embodiments described herein provide benefits and/or solve one or more of the foregoing or other problems in the art with systems, methods, and non-transitory computer-readable media that intelligently distribute and align design objects along vector splines within a digital design documents. To illustrate, in one or more embodiments, the disclosed systems arrange design objects equidistantly across a vector spline consisting of multiple defined curves (e.g., parametric curves). Further, in some embodiments the disclosed systems distribute the design objects between one or two selected anchor points on a given vector spline and enable user selection of a preferred alignment of the design objects relative to a variety of features. In one or more embodiments, for example, the disclosed systems utilize a recursive algorithm to identify placement locations with a uniform spread therebetween along the multiple curves of a given vector spline. In this manner, the disclosed systems provide precise, intuitive, and visible equidistant angular alignment of design objects with respect to a complex trajectory within the artwork.

Additional features and advantages of one or more embodiments of the present disclosure are outlined in the description which follows, and in part will be obvious from the description, or may be learned by the practice of such example embodiments.

### BRIEF DESCRIPTION OF THE DRAWINGS

This disclosure will describe one or more embodiments of the invention with additional specificity and detail by referencing the accompanying figures. The following paragraphs briefly describe those figures, in which:

FIG. 1 illustrates a diagram of a system environment in which a spline object arrangement system can operate in accordance with one or more embodiments.

FIG. 2 illustrates an example of the spline object arrangement system distributing and aligning design objects along a vector spline in accordance with one or more embodiments.

FIG. 3 illustrates an overview diagram of the spline object arrangement system generating a modified digital design document with design objects distributed along a vector spline in accordance with one or more embodiments.

FIG. 4 illustrates an example and overview diagram of the spline object arrangement system generating placement locations for distributing design objects along a vector spline in accordance with one or more embodiments.

FIG. 5 illustrates an overview diagram of the spline object arrangement system generating placement locations utilizing a mapping between vector curve position parameters of curve segments along a vector spline in accordance with one or more embodiments.

FIG. 6 illustrates examples and diagrams of the spline object arrangement system generating placement positions for distributing design objects between selected anchor points in accordance with one or more embodiments.

FIG. 7 illustrates examples of the spline object arrangement system distributing and aligning design objects across an open-path vector spline and a closed-path vector spline in accordance with one or more embodiments.

FIG. 8 illustrates an example graphical user interface for utilizing the spline object arrangement system to implement a custom distribution and alignment of design objects along a vector spline in accordance with one or more embodiments.

FIG. 9 illustrates exemplary results of utilizing the spline object arrangement system to distribute and align design objects along vector splines within digital design documents in accordance with one or more embodiments.

FIG. 10 illustrates a schematic diagram of the spline object arrangement system in accordance with one or more embodiments.

FIG. 11 illustrates a flowchart of a series of acts for generating a modified digital design document with design objects distributed along a vector spline in accordance with one or more embodiments.

FIG. 12 illustrates a block diagram of an example computing device for implementing one or more embodiments of the present disclosure.

### DETAILED DESCRIPTION

One or more embodiments described herein include a spline object arrangement system that intelligently distributes and aligns design objects along vector splines within a digital design documents. For example, in some embodiments, the spline object arrangement system precisely arranges and evenly distributes multiple design objects on a vector spline comprised of multiple curves. In some embodiments, the spline object arrangement system utilizes a recursive measurement approach to obtain precise spline division and control the spacing between design objects along vector splines consisting of either open or closed paths. Also, in one or more embodiments, the spline object arrangement system enables custom spacing of design objects along a given vector spline according to, for example, a user-selected distance between design objects and/or a user-selected span of the given vector spline.

To illustrate, in one or more embodiments, the spline object arrangement system generates and implements an accumulated length repository comprising accumulated lengths of curve segments along a vector spline. By searching the accumulated length repository, the spline object arrangement system identifies selected curve segments for placing design objects and generates corresponding placement locations along the selected curve segments for the design objects. Additionally, in some embodiments, the spline object arrangement system determines vector curve position parameters corresponding to positions along the curve segments of a vector spline and includes within the accumulated length repository a mapping between vector curve position parameters of the plurality of curve segments and accumulated lengths corresponding to the vector curve position parameters on the plurality of curve segments along the vector spline. Accordingly, in some embodiments, the spline object arrangement system searches the accumulated length repository to identify selected curve segments and to determine placement locations corresponding to vector curve position parameters of the selected curve segments by comparing fractional lengths for the placement locations with the accumulated lengths indicated within the accumulated length repository.

Following distribution of a series of design objects, in some embodiments, the spline object arrangement system aligns the design objects relative to the vector spline. In some embodiments, for example, the spline object arrangement system positions each of the design objects at an object angle orthogonal or tangent to the vector spline at each respective placement location. Moreover, in one or more embodiments, the spline object arrangement system rotates the design objects relative to a selected pivot point in response to user interactions with a graphical user interface. Also, in some embodiments, the spline object arrangement system receives a selected anchor point indicating a relative coordinate within the design objects for positioning the design objects on the vector spline and places the design objects along the vector spline accordingly.

As mentioned above, many conventional systems suffer from a number of issues in relation to computational inefficiency, inaccuracy, and operational flexibility. For example, some existing digital design systems inefficiently require designers looking to distribute and align multiple design objects across a given trajectory to perform excessive interactions and attempt multiple iterations of manual alignment to at least partially achieve a desired distribution of the various objects. For instance, existing digital design systems that provide conventional tools for object association with defined paths result in slow object positioning, requiring tedious manipulation of existing tools (e.g., by visually estimating object positions along the path) to attempt equal distances and preferred positional and angular alignment.

Relatedly, existing digital design systems suffer from computational inaccuracy. For instance, current systems that allow for free movement of design objects relative to a target trajectory/path are also often inaccurate, prone to user error and imprecise distribution and alignment. As such, a designer utilizing existing digital design systems often fails to accurately distribute and align a series of design objects on across any relatively complex trajectories within a digital design document. Specifically, in some instances, the lack of accurate tools for equidistant distribution and customized alignment of design objects limits a designer's ability to evenly space multiple objects along any defined path more complex than a straight line or simplistic curve or shape, resulting in visual imbalance and misalignments across multiple objects within digital design documents produced using current digital design systems.

As suggested, one or more embodiments of the spline object arrangement system provide several advantages over conventional digital design systems. For example, in one or more embodiments, the spline object arrangement system improves efficiency and accuracy over current digital design systems. In contrast to conventional digital design systems that require excessive user interactions to position objects at equal distances along a particular path, the spline object arrangement system intelligently determines placement locations for sets of design objects with equidistant spacing across vector splines comprising multiple curves. Specifically, the spline object arrangement system generates and utilizes an accumulated length repository to provide for efficient measurements of complex curvilinear paths to generate placement locations with automated precision. As such, the spline object arrangement system provides improved efficiency and accuracy over existing tools by providing equidistant placement of multiple objects along complex paths with minimal user interactions via a user interface.

Furthermore, the spline object arrangement system improves computational efficiency over conventional systems. As mentioned, conventional digital design systems suffer from computational inefficiency due to the significant computational resources required to model and analyze complex trajectories within a digital design document. In contrast, the spline object arrangement system reduces computation time (computational complexity) in determining precise placement locations for design objects by implementing an accumulated length repository as mentioned above. Furthermore, in some embodiments, the spline object arrangement system generates, to include within the aforementioned accumulated length repository, a mapping between vector curve position parameters of a plurality of curve segments of a vector spline and accumulated lengths corresponding to the vector curve position parameters on the plurality of curve segments along the vector spline to implement further efficiencies in generating placement locations for design objects using the accumulated length repository.

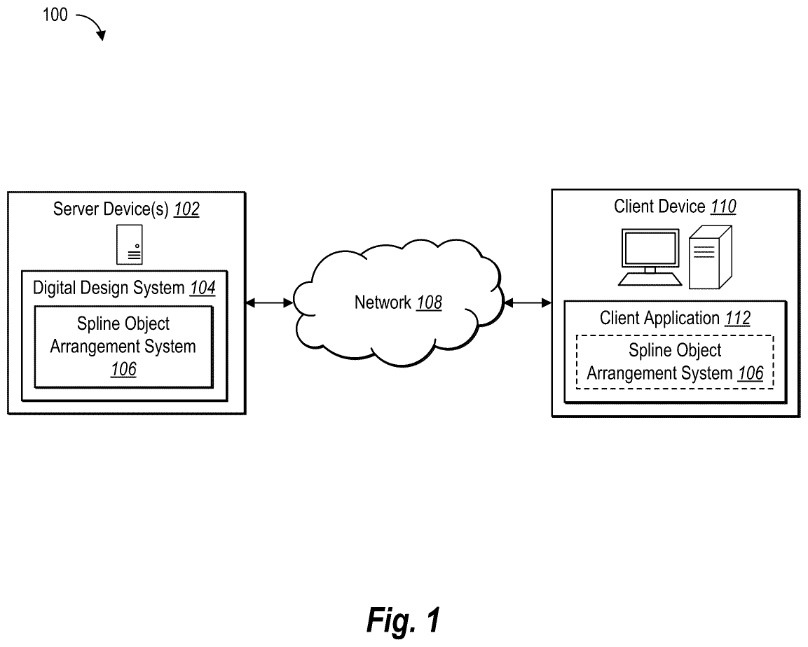

Additional details regarding the spline object arrangement system will now be provided with reference to the figures. For example, FIG. 1 illustrates a schematic diagram of an exemplary system environment 100 in which a spline object arrangement system 106 operates. As illustrated in FIG. 1, the system environment 100 includes server device(s) 102, a digital design system 104, the spline object arrangement system 106, a network 108, a client device 110, and a client application 112.

Although the system environment 100 of FIG. 1 is depicted as having a particular number of components, the system environment 100 is capable of having a different number of additional or alternative components (e.g., a different number of servers, client devices, or other components in communication with the spline object arrangement system 106 via the network 108). Similarly, although FIG. 1 illustrates a particular arrangement of the server device(s) 102, the network 108, and the client device 110, various additional arrangements are possible.

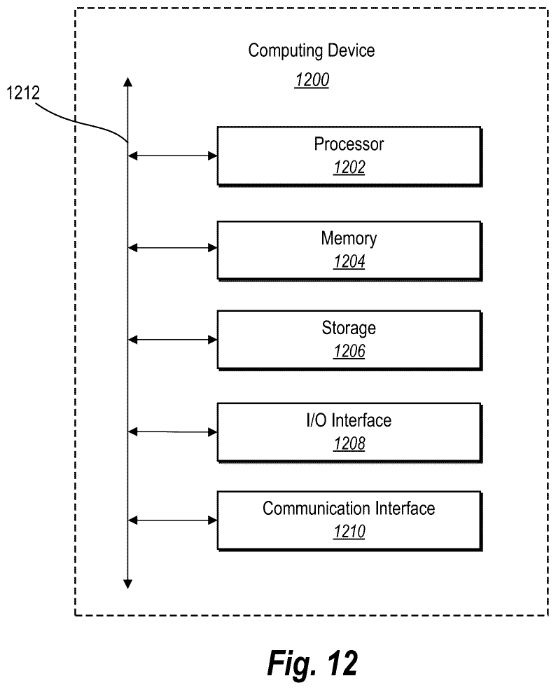

The server device(s) 102, the network 108, and the client device 110 are communicatively coupled with each other either directly or indirectly (e.g., through the network 108 discussed in greater detail below). Moreover, the server device(s) 102 and the client device 110 include one or more of a variety of computing devices (including one or more computing devices as discussed in greater detail in relation to FIG. 12).

As mentioned above, the system environment 100 includes the server device(s) 102. In one or more embodiments, the server device(s) 102 processes input to distribute and align design objects along a vector spline within a client application (e.g., a digital illustration application for generating or editing digital design documents) according to one or more user interactions for distributing the design objects along the vector spline within a digital design document. In one or more embodiments, the server device(s) 102 comprises a data server. In some implementations, the server device(s) 102 comprises a communication server or a web-hosting server.

In one or more embodiments, the client device 110 includes a computing device that is able to provide, for display via the client application 112, entities within a digital design document (e.g., a digital image such as a vector-based image or a raster-based image or a PDF file) such as objects, tools, user interface panels, and guides on a graphical user interface of the client application 112. For example, the client device 110 includes smartphones, tablets, desktop computers, laptop computers, head-mounted-display devices, or other electronic devices. The client device 110 includes one or more applications (e.g., the client application 112) for modifying objects (e.g., generating or editing digital design documents) in accordance with the digital design system 104. For example, in one or more embodiments, the client application 112 works in tandem with the spline object arrangement system 106 to distribute and align design objects along a vector spline within a digital design document via the client application 112. In particular, the client application 112 includes a software application installed on the client device 110. Additionally, or alternatively, the client application 112 of the client device 110 includes a software application hosted on the server device(s) 102 which may be accessed by the client device 110 through another application, such as a web browser.

To provide an example implementation, in some embodiments, the spline object arrangement system 106 on the server device(s) 102 supports the spline object arrangement system 106 on the client device 110. For instance, in some cases, the digital design system 104 on the server device(s) 102 gathers data for the spline object arrangement system 106. In response, the spline object arrangement system 106, via the server device(s) 102, provides the information to the client device 110. In other words, the client device 110 obtains (e.g., downloads) the spline object arrangement system 106 from the server device(s) 102. Once downloaded, the spline object arrangement system 106 on the client device 110 distributes and aligns design objects according to user interactions received via a graphical user interface of the client application 112.

In alternative implementations, the spline object arrangement system 106 includes a web hosting application that allows the client device 110 to interact with content and services hosted on the server device(s) 102. To illustrate, in one or more implementations, the client device 110 accesses a software application supported by the server device(s) 102. In response, the spline object arrangement system 106 on the server device(s) 102 provides a modified digital design document with design objects distributed and aligned along a vector spline to the client device 110 for display.

To illustrate, in some cases, the spline object arrangement system 106 on the client device 110 receives, via a digital design document displayed within the client application 112, a user interaction for distributing a plurality of design objects along a vector spline comprising a plurality of curve segments. The client device 110 transmits the requested distribution/action to the server device(s) 102. In response, the spline object arrangement system 106 on the server device(s) 102 generates a modified digital design document to display via the graphical user interface of the client application 112.

Indeed, in some embodiments, the spline object arrangement system 106 is implemented in whole, or in part, by the individual elements of the system environment 100. For instance, although FIG. 1 illustrates the spline object arrangement system 106 implemented or hosted on the server device(s) 102, different components of the spline object arrangement system 106 are able to be implemented by a variety of devices within the system environment 100. For example, one or more (or all) components of the spline object arrangement system 106 are implemented by a different computing device (e.g., the client device 110) or a separate server from the server device(s) 102. Indeed, as shown in FIG. 1, the client device 110 includes the spline object arrangement system 106. Example components of the spline object arrangement system 106 will be described below with regard to FIG. 12.

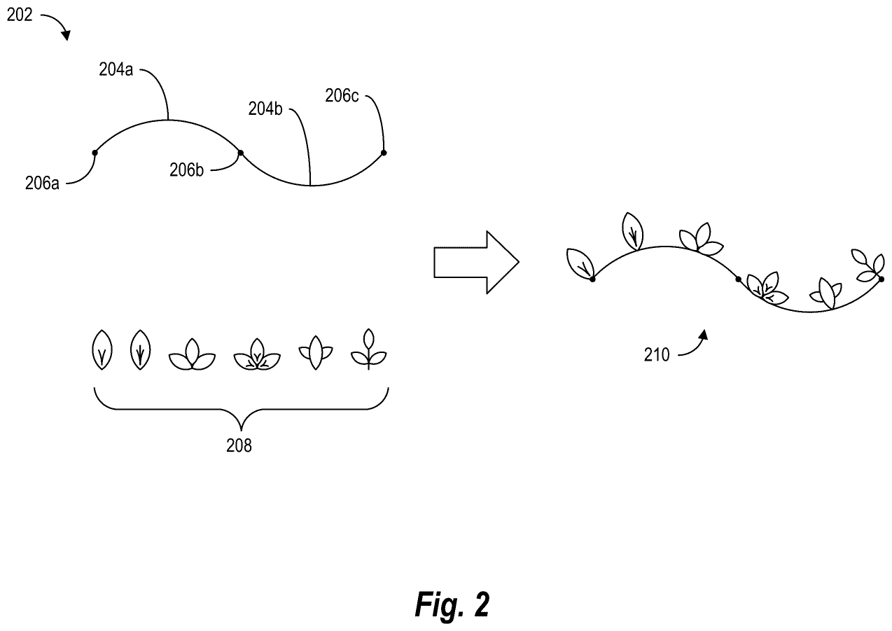

As mentioned above, in certain embodiments, the spline object arrangement system 106 performs operations for distributing and aligning design objects along a vector spline comprising multiple curve segments. To illustrate, FIG. 2 shows an example of the spline object arrangement system 106 distributing and aligning a plurality of design objects 208 along a vector spline 202 in accordance with one or more embodiments.

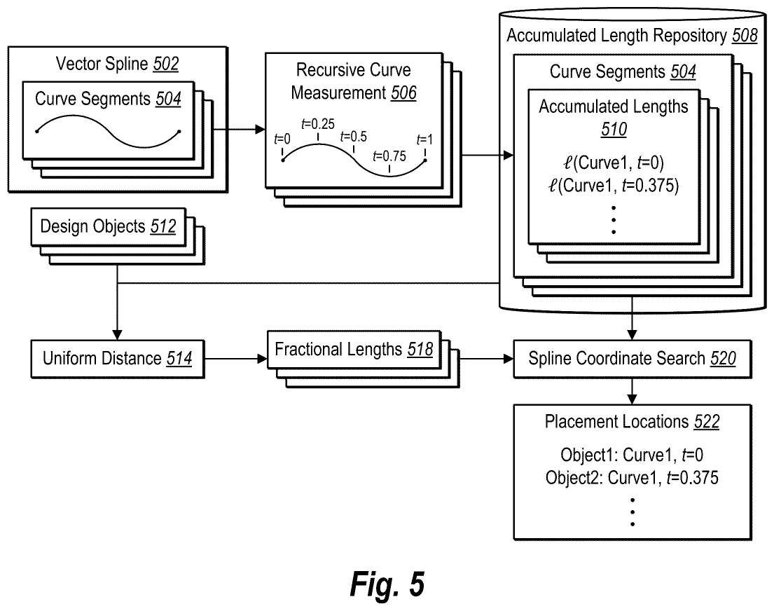

As shown in FIG. 2, the spline object arrangement system 106 identifies, generates, or otherwise receives the vector spline 202. In some embodiments, for example, a vector spline comprises multiple linear lines, almost linear lines, or curved lines. In one or more embodiments, for example a vector spline comprises multiple Bezier curve segments of a Bezier curve, defined by a specific set of control points, that represent a smooth, parametric curve. In some implementations, for example, a cubic Bezier curve is represented as:

$$B ( t ) = {( 1 - t )}^{3} {P}_{0} + 3 {( 1 - t )}^{2} {tP}_{1} + 3 ( 1 - t ) {t}^{2} {P}_{2} + {t}^{3} {P}_{3} for t ∈ [ 0 , 1 ]$$

where t represents a vector curve position parameter corresponding to positions along the Bezier curve or segment (e.g., as further discussed below in relation to FIG. 5), P₀ represents a starting point of the Bezier curve or segment, P₁ and P₂ represent intermediate control points of the Bezier curve or segment, and P₃ represents the end point of the Bezier curve or segment. In certain implementations, these control points are provided as coordinates in two-dimensional or three-dimensional space, such as P₀=(x₀,y₀) or P₀=(x₀,y₀,z₀), respectively.

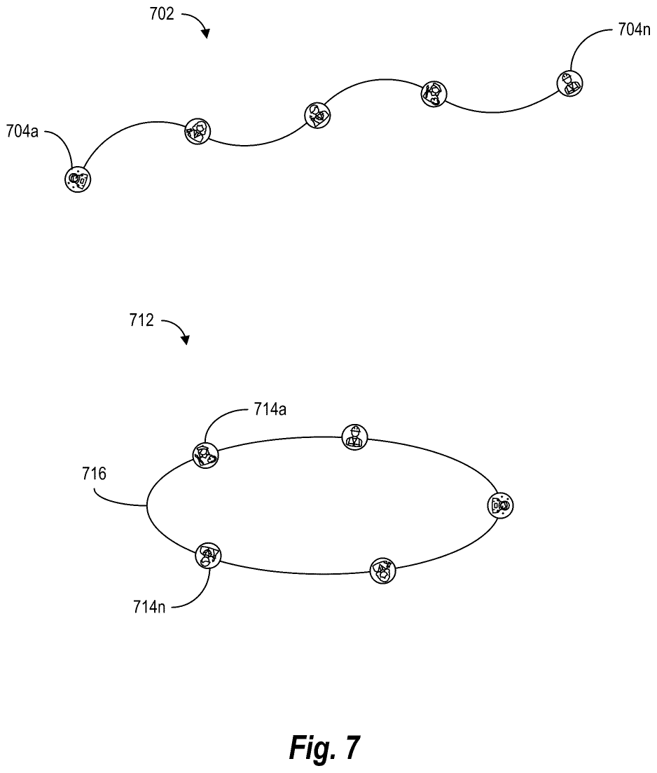

As shown in FIG. 2, the vector spline 202 comprises a first curve segment 204a and a second curve segment 204b. While the vector spline 202 consists of two curve segments, vector splines of other implementations can include additional curve segments. As also illustrated, the first curve segment 204a comprises a first position 206a of the vector spline 202 (e.g., a starting point of the first curve segment 204a and an initial position of the vector spline 202) and a second position 206b of the vector spline 202 (e.g., an end point of the first curve segment 204a and an intermediate position along the vector spline 202). Also, the second curve segment 204b comprises the second position 206b (e.g., a starting point of the second curve segment 204b, the end point of the first curve segment 204a, and the intermediate position along the vector spline 202) and a third position 206c of the vector spline 202 (e.g., an end point of the second curve segment 204b and a terminal position of the vector spline 202). As mentioned above, in certain implementations, the vector spline 202 comprises additional control points, such as one or more intermediate control points (e.g., as described above in relation to cubic Bezier curves) along the first curve segment 204a and/or the second curve segment 204b. Moreover, while FIG. 2 shows the vector spline 202 comprising an open path between the first position 206a and the third position 206c, in some implementations, a vector spline comprises a closed path with an additional curve (e.g., an implicit curve segment) spanning between a terminal position and an initial position of the vector spline (e.g., as further described below in relation to FIG. 7).

As also shown in FIG. 2, the spline object arrangement system 106 identifies, generates, or otherwise receives the plurality of design objects 208. In some embodiments, for example, a design object includes a collection of pixels that depicts a shape, person, place, text, thing, or other design element. In certain implementations, the spline object arrangement system 106 receives the design objects 208 from one or more of a user-initiated import, a user selection from a collection of design objects, or design objects created by a user within the digital design object prior to selecting the design objects 208 for distribution along the vector spline 202.

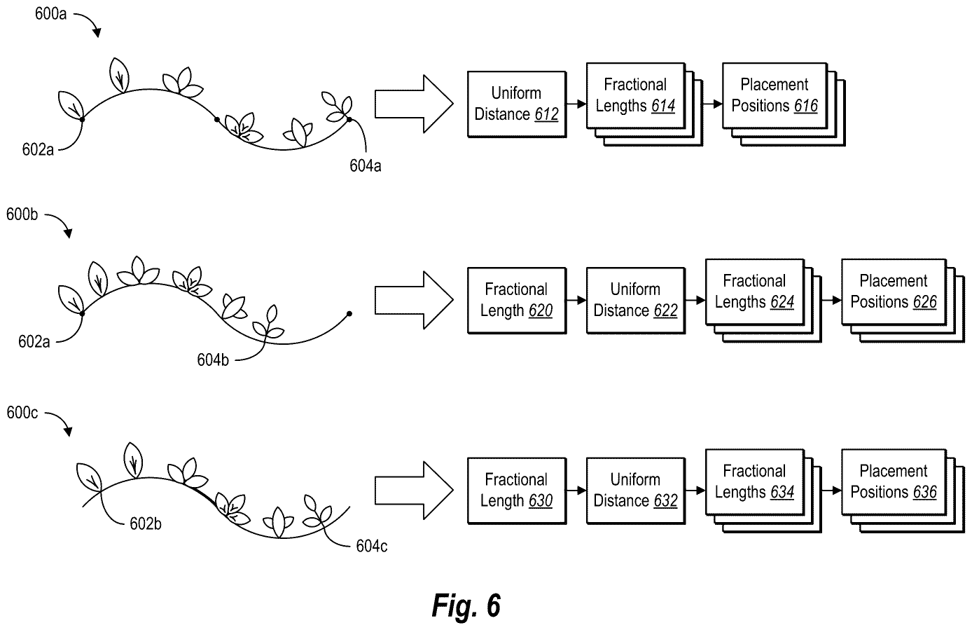

As illustrated, the spline object arrangement system 106 distributes the design objects 208 along the vector spline 202 between two positions on the vector spline 202 (e.g., in response to receiving a corresponding user interaction within a digital design document). As illustrated, for example, the spline object arrangement system 106 distributes the design objects 208 between an initial placement location corresponding to the first position 206a (e.g., the initial position of the vector spline 202) and a final placement location corresponding to the third position 206c (e.g., the terminal position of the vector spline 202). Accordingly, as illustrated, the spline object arrangement system 106 generates a modified digital design 210 (e.g., a modified digital design document) with the objects 208 evenly (e.g., equidistantly) distributed along the vector spline 202. Moreover, in some implementations, the spline object arrangement system 106 distributes design objects between initial and/or final placement locations other than the initial and terminal positions of a vector spline, such as one or two respective positions selected by a user for distribution of a set of design objects (e.g., as further described below in relation to FIG. 6).

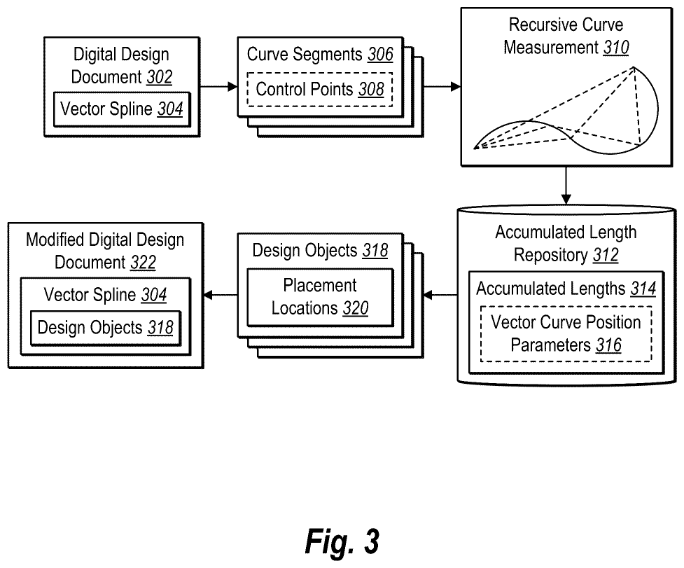

As mentioned above, in one or more embodiments, the spline object arrangement system 106 distributes and aligns a set of design objects along a vector spline within a digital design document to generate a modified digital design document. For example, FIG. 3 illustrates a schematic overview of the spline object arrangement system 106 generating a modified digital design document 322 with a set of design objects 318 distributed along a vector spline 304 according to one or more embodiments.

As shown in FIG. 3, the spline object arrangement system 106 identifies, generates, or otherwise accesses a digital design document 302 comprising the vector spline 304. In some implementations, for example, a user creates, provides, or selects the vector spline 304. As illustrated, the vector spline 304 includes multiple curve segments 306. As mentioned above, in some embodiments, the curve segments 306 comprise curves (e.g., Bezier curves) defined by control points 308. In some implementations, the curve segments 306 include curvilinear paths of varying complexity, such as linear paths, near linear paths, arcs, semi-circles, parametric curves, and so forth.

As also shown in FIG. 3, the spline object arrangement system 106 performs a recursive curve measurement 310 to determine accumulated lengths 314 of the curve segments 306 along the vector spline 304. In some embodiments, for example, the spline object arrangement system 106 performs the recursive curve measurement 310 to generate an accumulated length repository 312 including the accumulated lengths 314 along the vector spline 304 at each starting point and end point of the curve segments 306. Also, in some embodiments, the spline object arrangement system 106 determines the accumulated lengths 314 to include a length of the vector spline 304 at each of the control points 308 of the curve segments 306. Moreover, in one or more embodiments, the spline object arrangement system 106 utilizes the recursive curve measurement 310 to determine the accumulated lengths 314 at various positions along each of the curve segments 306 and includes, within the accumulated length repository 312, a mapping of the accumulated lengths 314 at the various positions to corresponding vector curve position parameters 316 for the respective curve segments 306 (e.g., as further described below in relation to FIG. 5).

As mentioned, the spline object arrangement system 106 implements the recursive curve measurement 310 to determine the accumulated lengths 314 of the curve segments 306 along the vector spline 304. To illustrate, in one or more embodiments, the recursive curve measurement 310 iteratively splits the curve segments 306 into pairs of respective sub-curves (e.g., sub-Bezier curves) until a difference between (i) respective calculated lengths from starting point to end point (e.g., a measured distance between control points P₀ and P₃ of a given sub-curve) and (ii) respective calculated lengths between control points along the respective sub-curves (e.g., aggregated measured distances from control points P₀ to P₁, P₁ to P₂, and P₂ to P₃ of a given sub-curve) satisfies a threshold convergence (e.g., a zero value or a value near zero). Upon determining a measured length of each of the curve segments 306, the spline object arrangement system 106 determines the respective accumulated lengths 314 for the curve segments 306 by combining the measured lengths in succession along the vector spline 304 until a total spline length is determined.

In some embodiments, for example, the spline object arrangement system 106 performs the recursive curve measurement 310 to determine a spline length of the vector spline 304 and the accumulated lengths 314 of the curve segments 306 by executing respective algorithms represented by the following pseudo code:

Algorithm 1 Calculate Spline Length

1: totalLength ← 0
2: accumulativeLengths ← [ ]
3: for each segment in spline do
4: segmentLength ← RecursiveBezierLength(segment)
5: totalLength ← totalLength + segmentLength
6: accumulativeLengths.append(totalLength)
return totalLength, accumulativeLengths

Algorithm 2 Recursive Bezier Length

1: P₀, P₁, P₂, P₃ ← bezier.controlPoints
2: chordLength ← Distance(P₀, P₃)
3: controlPointLength ← Distance(P₀, P₁) + Distance(P₁, P₂) + Distance(P₂, P₃)
4: if abs(chordLength − controlPointLength) ᵢ tolerance then return chordLength
5: else
6: bezier1, bezier2 ← SplitBezier(bezier) return RecursiveBezierLength(bezier1, tolerance)
+ RecursiveBezierLength(bezier2, tolerance)

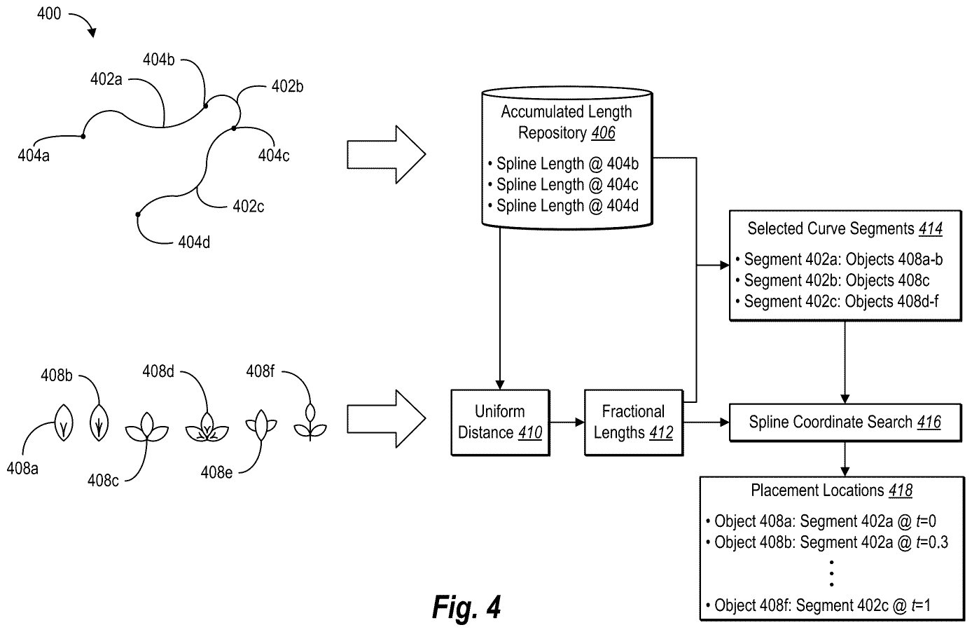

As shown in FIG. 3, the spline object arrangement system 106 generates placement locations 320 for positioning the design objects 318 along the vector spline 304 by searching the accumulated length repository 312 (e.g., as described below in relation to FIG. 4 and FIG. 5). Accordingly, the spline object arrangement system 106 generates the modified digital design document 322 by positioning the design objects 318 along the vector spline 304 at the placement locations 320 generated utilizing the accumulated length repository 312.

As mentioned above, in one or more embodiments, the spline object arrangement system 106 generates and implements an accumulated length repository to generate placement locations for distributing design objects along a vector spline. For example, FIG. 4 shows an illustrative example and overview diagram of the spline object arrangement system 106 generating placement locations 418 for distributing design objects 408a-408f along a vector spline 400 in accordance with one or more embodiments.

As illustrated, the spline object arrangement system 106 identifies, generates, or otherwise receives the vector spline 400 comprising a first curve segment 402a, a second curve segment 402b, and a third curve segment 402c. As shown, the first curve segment 402a includes a starting point at a first position 404a of the vector spline 400 (e.g., an initial position of the vector spline 400) and an end point at a second position 404b of the vector spline 400 (e.g., an intermediate position along the vector spline 400). As shown, the second curve segment 402b includes a starting point at the second position 404b and an end point at a third position 404c of the vector spline 400 (e.g., an intermediate position along the vector spline 400). As shown, the third curve segment 402c includes a starting point at the third position 404c and an end point at a fourth position 404d of the vector spline 400 (e.g., a terminal position of the vector spline 400).

As shown in FIG. 4, the spline object arrangement system 106 receives (e.g., via a digital design document) a user interaction for distributing the design objects 408a-408f along the vector spline 400. In response, the spline object arrangement system 106 determines a uniform distance 410 for placing the design objects 408a-408f between an initial placement location and a final placement locations along the vector spline 400. In some cases, for instance, wherein the initial and final placement locations are the initial and terminal positions (e.g., the first position 404a and the fourth position 404d) of the vector spline 400, respectively, the spline object arrangement system 106 determines the uniform distance 410 based on a total spline length. In other cases, wherein either of the initial placement location or the final placement location comprises an intermediate position along the vector spline 400, the spline object arrangement system 106 determines the uniform distance 410 based on a fractional length of the vector spline 400 measured between the initial and final placement positions (e.g., as further described below in relation to FIG. 6).

As shown in FIG. 4, the spline object arrangement system 106 utilizes an accumulated length repository 406 of accumulated lengths of the curve segments 402a-402c to determine the uniform distance 410 (e.g., based on a total spline length or a fractional length of the vector spline 400). As illustrated, the accumulated length repository 406 includes accumulated lengths of the vector spline 400 at respective end points—positions 404b-404c—of the curve segments 402a-402c (e.g., as described above in relation to FIG. 3).

In some embodiments, for example, the spline object arrangement system 106 determines the uniform distance 410 by executing an algorithm represented by the following pseudo code:

Algorithm 3 Spread Calculation

1: N ← Number of Objects to be placed on Key Path
2: L ← Total length of Key Path Spline
3: if Key Path is closed then
4: NumIntervals ← N
5: else
6: NumIntervals ← N − 1
$7 : MaxSpreadInterval ← \frac{L}{N - 1}$

wherein “Key Path” corresponds to the object placement path between the initial placement positions and “Spread” corresponds to the uniform distance 410, which is further defined as

$$I = \frac{L}{NumIntervals} ,$$

for k∈[0,N−1], where I represents the uniform distance 410.

Based on the uniform distance 410, the spline object arrangement system 106 determines fractional lengths 412 of the vector spline 400 for placement of the design objects 408a-408f and searches the accumulated length repository 406 to determine selected curve segments 414 based on the fractional lengths 412. As illustrated, for example, the selected curve segments 414 include the curve segment 402a for the design objects 408a-408b, the curve segment 402b for the design object 408c, and the curve segments 402c for the design objects 408d-f.

As also shown in FIG. 4, the spline object arrangement system 106 performs a spline coordinate search 416 to generate the placement locations 418 for distributing the design objects 408a-408f along the vector spline 400. As illustrated, for example, the placement locations 418 include a location corresponding to vector curve position parameter t=0 on the first curve segment 402a for the design object 408a, a location corresponding to vector curve position parameter t=0.3 on the first curve segment 402a for the design object 408b, a location corresponding to vector curve position parameter t=1 on the third curve segment 402c for the design object 408f, and so forth.

As mentioned, the spline object arrangement system 106 utilizes the accumulated length repository 406 to implement the spline coordinate search 416 to generate the placement locations 418 for distributing the design objects 408a-408f along the vector spline 400. To illustrate, in one or more embodiments, for a given design object with a corresponding selected curve segment identified for a respective fractional length, the spline coordinate search 416 determines a target length on the corresponding selected curve segment and utilizes a recursive curve measurement to generate a respective placement location (e.g., determining a vector curve position parameter corresponding to the respective placement location on the selected curve segment) by iteratively splitting the selected curve segments until satisfying a threshold convergence (e.g., as described above in relation to FIG. 3). Alternatively, in some embodiments, the spline object arrangement system 106 stores, within the accumulated length repository 406, a mapping of vector curve position parameters of the curve segments 402a-402c and accumulated lengths of the curve segments 402a-402c at various positions and utilizes the mapping to perform the spline coordinate search 416 without additional recursive curve measurements (e.g., as further described below in relation to FIG. 5).

In some embodiments, for example, the spline object arrangement system 106 searches the accumulated length repository 406 to determine the selected curve segments 414 and performs the spline coordinate search 416 to generate the placement locations 418 by executing an algorithm represented by the following pseudo code:

Algorithm 4 FindCoordinatesOnSpline

```
  1: procedure FINDONSPLINE(N, accumulatedLengths)
  2: Interval ← SpreadCalculation(N,accumulatedLengths[N−1)
  3: for index = 0 to N − 1 do
  4: FractionalLength ← index times Interval
  5: FindCoordinatesOnSpline(FractionalLength,accumulatedLengths,
CoordinatesVector)
  6: procedure FINDCOORDINATESONSPLINE(FractionalLength, accumulatedLengths,
CoordinatesVector)
  7: segmentIndex ← BinarySearch(accumulatedLengths, lengthFraction)
  8: lengthOnSegment ← lengthFraction −accumulatedLengths[segmentIndex − 1]
  9: if lengthOnSegment ≤ 0 then
10: t_{mid} ← 0
11: else
12: bezierSegment ← GetBezierSegment(segmentIndex)
13: t_{mid} ← FindTValue(bezierSegment, lengthOnSegment)
14: Push Back (segmentIndex, tmid) in coordinates vector
15: return coordinates vector
```

Algorithm 5 BinarySearch BezSeg N TValue

```
  1: procedure BINARYSEARCH(accumulatedLengths, lengthFraction)
  2: low ← 0
  3: high ← length(accumulatedLengths) − 1
  4: while low < high do
  5:  $mid ← ⌊ \frac{low + high}{2} ⌋$
  6:  if accumulatedLengths[mid] < lengthFraction then
  7:  low ← mid + 1
  8:  else
  9:  high ← mid
10:  return low
```

Algorithm 6 Binary Search TValue

```
  1: procedure FINDTVALUE(bezierSegment, targetLength)
  2: bezLength ← CalculateBezierLength(bezierSegment)
  3: if targetLength ≤ 0 b
  4: return 0
  5: else if targetLength ≥ bezLength then
  6: return 1
  7: else
  8: t0 ← 0
  9: t1 ← 1
10:  $tmid ← \frac{targetLength}{bezLength}$
11: while true do
12: DivideBezier(bezierSegment, tmid)
13: lengthB1 ← CalculateBezierLength(b1)
14: if abs(lengthB1 - targetLength) < kBezierTolerance then
15: return tmid
16: else if lengthB1 < targetLength then
17: t0 ← tmid
18: else
19: t1 ← tmid
20:  $tmid ← \frac{t 0 + t 1}{2}$
```

As mentioned above, in some embodiments, the spline object arrangement system 106 generates, for a given vector spline, an accumulated length repository comprising a mapping between vector curve position parameters of curve segments of the vector spline and accumulated lengths corresponding to the vector curve position parameters on the plurality of curve segments along the vector spline. For example, FIG. 5 illustrates the spline object arrangement system 106 generating and implementing, for a vector spline 502, an accumulated length repository 508 including a mapping of vector curve position parameters of curve segments 504 to accumulated lengths 510 of positions on the curve segments 504 according to one or more embodiments.

As shown in FIG. 5, the spline object arrangement system 106 identifies, generates, or otherwise receives the vector spline 502 comprising the curve segments 504. As illustrated, the spline object arrangement system 106 performs a recursive curve measurement 506 (e.g., as described above in relation to FIG. 3) to generate an accumulated length repository 508 with a mapping between vector curve position parameters of the curve segments 504 and accumulated lengths 510 corresponding to the vector curve position parameters on the curve segments 504 along the vector spline 502. In some embodiments, for example, the spline object arrangement system 106 determines and stores (within the accumulated length repository 508) accumulated lengths along one or more of the curve segments 504 in addition to the total accumulated lengths of the curve segments 504 at their respective end points (e.g., as described above in relation to FIG. 4). In some such embodiments, for example, the spline object arrangement system 106 determines a number of positions along a given curve segment to include within the accumulated length repository 508 based on a relative flatness of the given curve segment (e.g., determining and storing less positions on relatively flat curve segments compared to relatively curved or steep curve segments). As illustrated in FIG. 5, for example, the accumulated length repository 508 includes at least one accumulated length of a first curve segment of the curve segment 504 at a vector curve position parameter of t=0.375 on the first curve segment.

In some embodiments, for example, the spline object arrangement system 106 generates the accumulated length repository 508 by executing an algorithm represented by the following pseudo code:

Algorithm 7
Algorithm 7 Cache Creation

```
  1: procedure OPTIMIZATION
  2: TVector ← vector of (bez segment,tvalue) vs spline length till this position
  3: cumulativeLength = 0
  4: for each bezier in the bezier spline of key Path do
  5:  flatness ← GetFlatness(bezier)
  6:  NumTValues ← 1
  7: flatness
  8:  BezierLength = RecursiveBezierLength(bezier)
  9:  for Num = 0 to NumTValues do
10:   $tValue ← \frac{Num}{NumTValues}$
11:  BezLength ← tValue * BezierLength
12:  cumulativeLength = cumulativeLength + BezLength
13:  TVector.pushback(bezSegment, tValue, cumulativeLength)
```

wherein the “RecursiveBezierLength” function represents the recursive curve measurement 506 which, in some embodiments, the spline object arrangement system 106 performs as described above in relation to FIG. 3 (e.g., Algorithm 3).

As also shown in FIG. 5, the spline object arrangement system 106 determines a uniform distance 514 for distributing a set of design objects 512 along the vector spline 502. As mentioned previously, the spline object arrangement system 106 determines the uniform distance 514 based on either a total spline length or a fractional length between selected initial and final placement locations (e.g., as further described below in relation to FIG. 6). As also illustrated, the spline object arrangement system 106 determines fractional lengths 518 of the vector spline 502 based on the uniform distance 514 and, utilizing the accumulated length repository 508, performs a spline coordinate search 520 to generate placement locations 522 for positioning the design objects 512 along the vector spline 502.

As mentioned, the spline object arrangement system 106 implements a spline coordinate search 520 to determine the placement locations 522 based on the mapping of vector curve position parameters to the accumulated lengths 510 of the curve segments 504 included within the accumulated length repository 508. To illustrate, in one or more embodiments, for a given design object with a corresponding selected curve segment identified for a respective fractional length, the spline coordinate search 520 searches the accumulated lengths 510 for the corresponding selected curve segment within the accumulated length repository 508 for a nearest accumulated length to the respective fractional length. In some implementations, in response to determining that a difference between the respective fractional length and the nearest accumulated length satisfies a tolerance value, the spline object arrangement system 106 generates a placement location for the given design object utilizing the vector curve position parameter corresponding to the nearest accumulated length on the selected curve segment (e.g., cached within the accumulated length repository 508 during the recursive curve measurement 506). In some implementations, in response to determining that the fractional length falls between consecutive accumulated lengths (e.g., when the nearest accumulated length fails to satisfy the tolerance value), the spline object arrangement system 106 generates the placement location for the given design object at a midpoint between the consecutive accumulated lengths by determining a vector curve position parameter corresponding to the midpoint based on respective vector curve position parameters corresponding to the consecutive accumulated lengths on the selected curve segment (e.g., cached within the accumulated length repository 508).

In some embodiments, for example, the spline object arrangement system 106 performs the spline coordinate search 520 to generate the placement locations 522 by executing an algorithm represented by the following pseudo code:

Algorithm 8 Optimized Find Coordinates On Spline

```
  1: procedure OPTIMIZED FINDCOORDINATESONSPLINE(FractionalLength, TVector)
  2: FractionalLength ← Length of spline on which to place the object
  3: binary search on the cached TVector for the fractional Length
  4: low ← 0
  5: high ← length(TVector) - 1
  6: while low < high do
  7:  $mid ← ⌊ \frac{low + high}{2} ⌋$
  8: if T then Vector[mid].lengthOnSegment equalWithinTol of FractionalLength
  9: return mid
10: if TVector[mid].lengthOnSegment < FractionalLength then
11: low ← mid + 1
12: else
13: high ← mid - 1
14: return - 1
15: nearestTPos ← BinarySearch as above
16: return the TVector[nearestTPos].bezSegment and TVector[nearestTPos].tValue
```

As mentioned above, in some embodiments, the spline object arrangement system 106 distributes and aligns design objects between initial and final placement positions along a vector spline according to user selections/interactions. For example, FIG. 6 shows illustrative examples and overview diagrams of the spline object arrangement system 106 generating placement positions for distributing design objects between selected initial and final placement locations along a vector spline in accordance with one or more embodiments.

As shown in FIG. 6, the spline object arrangement system 106 generates (or receives) an initial digital design 600a comprising a set of design objects evenly (e.g., equidistantly) distributed along a vector spline between an initial placement location 602a coinciding with an initial position of the vector spline and a final placement location 604a coinciding with a terminal position of the vector spline. Based on the total spline length between the initial placement location 602a and the final placement location 604a, the spline object arrangement system 106 determines a uniform distance 612 between the design objects and, based on the uniform distance 612, determines fractional lengths 614 of the vector spline and generates placement positions 616 along the vector spline according to the determined fractional lengths 614 for placement of the design objects as illustrated (e.g., as further described above in relation to FIGS. 3-5).

As mentioned, in some embodiments, the spline object arrangement system 106 receives user interactions indicating a custom spacing of design objects or a selection of initial and/or final placement positions other than an initial and/or terminal position of the vector spline, respectively. As also shown in FIG. 6, for example, the spline object arrangement system 106 generates a modified digital design 600b comprising the set of design objects evenly (e.g., equidistantly) distributed between the initial placement location 602a and a modified final placement location 604b. As illustrated, the modified digital design 600b includes the design objects distributed across a fractional length 620 of the vector spline from the initial placement location 602a to the modified final placement location 604b, thus resulting in a uniform distance 622 different than the uniform distance 612 of the initial digital design 600a. Accordingly, the spline object arrangement system 106 determines fractional lengths 624 based on the uniform distance 622 and generates placement positions 626 for placement of the design objects on the vector spline based on the determined fractional lengths 624.

As also shown in FIG. 6, upon user selection of both a modified initial placement location 602b and a modified final placement location 604c, the spline object arrangement system 106 generates a modified digital design 600c with the design objects evenly (e.g., equidistantly) distributed along the vector spline between the modified initial placement location 602b and the modified final placement location 604c. As illustrated, the modified digital design 600c includes the design objects distributed across a fractional length 630 of the vector spline from the modified initial placement location 602b to the modified final placement location 604c, thus resulting in a uniform distance 632 different than the uniform distance 612 of the initial digital design 600a. Accordingly, the spline object arrangement system 106 determines fractional lengths 634 based on the uniform distance 632 and generates placement positions 636 for placement of the design objects on the vector spline based on the determined fractional lengths 634.

In some embodiments, for example, the spline object arrangement system 106 determines the fractional length of a vector spline between selected initial and final placement positions by executing an algorithm represented by the following pseudo code:

Algorithm 9 Deduce Fractional Length Of spline

1: procedure DEDUCE FRACTIONAL LENGTH OF SPLINE(bezSegment, TValue,
accumulatedLengths)
2: LengthTillPrevBez ← accumulatedLength[bezierSegment - 1]
3: PartialLen = Get the length of input Bezier Segment till tValue
4: StartPositionLength = LengthTillPrevBez + PartialLen
5: $StartPosFractionalLength ← \frac{StartPositionLength}{TotalSplineLength}$
6: Similarly, calculate end PositionLength Fractional Length

As mentioned above, in one or more embodiments, the spline object arrangement system 106 distributes and aligns design objects along vector splines comprising either open or closed trajectories or paths. For example, FIG. 7 shows illustrative examples of the spline object arrangement system 106 distributing and aligning design objects across an open-path vector spline 702 and a closed-path vector spline 712 in accordance with one or more embodiments.

As shown in FIG. 7, the open-path vector spline 702 forms an open path which begins at an initial position 704a and ends at a terminal position 704n, whereas the closed-path vector spline 712 includes a path from an initial position 714a to a terminal position 714n with an implicit curve 716 between the terminal position 714n and the initial position 714a (e.g., a Bezier curve with a starting point at the terminal position 714n and an end point at the initial position 714a) to form a closed loop. As mentioned above, in one or more embodiments, the spline object arrangement system 106 accounts for both open and closed paths when aligning and distributing design objects thereon.

In one or more embodiments, the spline object arrangement system 106 determines a path between initial and final placement points partially spanning a closed-path vector spline by identifying respectively selected curve segments for the initial and final placement points along the vector spline. In particular, in some embodiments, the spline object arrangement system 106 determines a respective fractional lengths between an initial position on the vector spline and the initial and final placement positions along the vector spline using one or more of the methods described herein (e.g., a recursive curve measurement as described above in relation to FIG. 3).

In some embodiments, for example, the spline object arrangement system 106 generates placement locations along vector splines comprising open or closed paths by executing an algorithm represented by the following pseudo code:

Algorithm 10 Open/Closed Path - Find Coordinates On Spline

1: procedure OPEN/CLOSED PATH - FIND COORDINATES ON
SPLINE(StartPosFractionalLength)
2: for Num = 0 to NumObjects do
3: FractionalLength = Length of spline on which to place the object wrt to initial
start
4: NewFractionalLength = StartPosFractionalLength + FractionalLength
5: if i thents a closed path
6: replace the object in round robin fashion
7: NewFractionalLength = RoundRobinAdjustment(NewFractionalLength)
8: OPTIMIZED FINDCOORDINATESONSPLINE ( NewFractionalLength,
TVector )

Algorithm 11 RoundRobinAdjustment

1: procedure ROUNDROBINADJUSTMENT(FractionalLength)
2: FractionalLength ← Length of spline on which to place the object
3: if F thenractionalLength > 1
4: FractionalLength −= 1
5: else if F thenractionalLength < 0
6: FractionalLength += 1

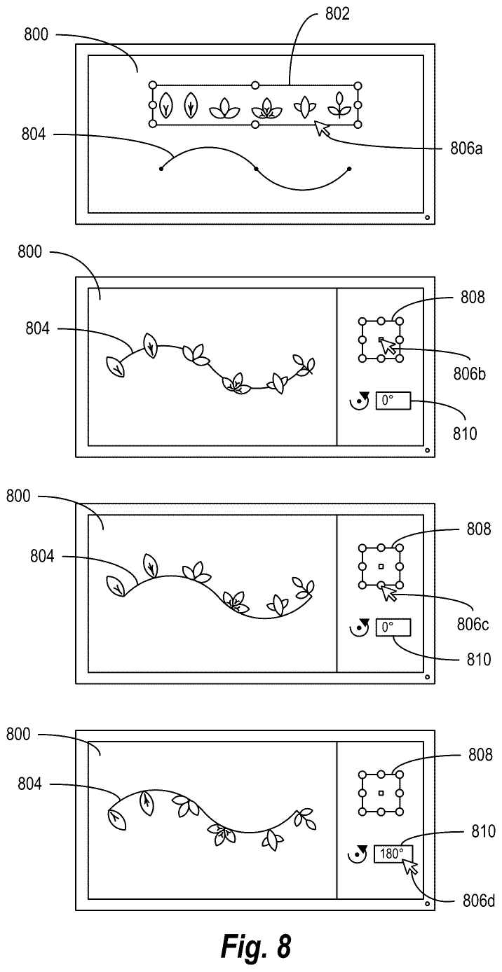

As mentioned above, in some embodiments, the spline object arrangement system 106 provides distributes and aligns design objects along vector splines according to user selections and interactions with a graphical user interface. For example, FIG. 8 illustrates a graphical user interface 800 for utilizing the spline object arrangement system 106 to implement a custom distribution and alignment of design objects 802 along a vector spline 804 in accordance with one or more embodiments.

As shown in FIG. 8, the spline object arrangement system 106 provides the graphical user interface 800 for creating, editing, and/or otherwise interacting with a digital design document. As illustrated, the spline object arrangement system 106 receives a first user interaction 806a with the graphical user interface 800 including a selection of the design objects 802. Then, upon detection of a second user interaction 806b selecting a centered anchor point within a selection grid 808, the spline object arrangement system 106 distributes the design objects 802 along the vector spline 804 with the design objects 802 anchored to the vector spline at a relative center of each object. In the illustrated implementation, the spline object arrangement system 106 distributes the design objects from an initial position of the vector spline 804 to a terminal position of the vector spline 804. Alternatively, in some implementations, the spline object arrangement system 106 distributes the design objects 802 between two selected positions along the vector spline 804 (e.g., as discussed above in relation to FIG. 6). As illustrated, the spline object arrangement system 106 also initially aligns the design objects 802 at a relative angle orthogonal to the vector spline 804. In other implementations, the spline object arrangement system 106 initially distributes the design objects 802 along the vector spline 804 either (a) at a different initial angle relative to the vector spline 804 or the design document, or (b) without rotating or otherwise re-orienting the design objects upon distributing them along the vector spline 804.

As also shown in FIG. 8, the spline object arrangement system 106 receives, via the graphical user interface 800, a user interaction 806c with a lower middle anchor point within the selection grid 808 and, in response, positions each of the design objects 802 at the selected anchor point along the vector spline 804. As also illustrated, in some implementations, the spline object arrangement system 106 aligns the design objects 802 at the relative angle orthogonal to the vector spline 804. In other implementations, the spline object arrangement system 106 aligns or re-aligns design objects according to user-selected preferences. As shown in FIG. 8, for example, the spline object arrangement system 106 rotates the design objects 802 relative to a selected pivot point (e.g., a pivot point selected from the selection grid 808) in response to receiving a user interaction 806d with an angle selection prompt 810 indicating a modification to the initial object angle (e.g., to rotate the design objects by 180 degrees). Indeed, in various implementations, the spline object arrangement system 106 receives and implements a variety of user interactions for distributing, aligning, rotating, and otherwise adjusting design objects relative to a vector spline.

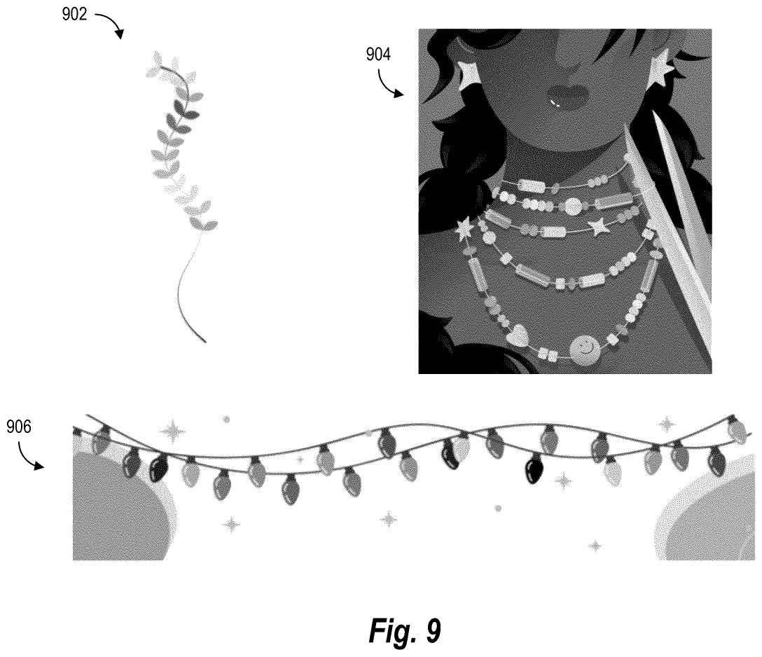

As mentioned above, in various implementations, the spline object arrangement system 106 distributes and aligns design objects along vector splines with precise and/or customized spacing for an aesthetic appearance. To illustrate, FIG. 9 provides exemplary results of utilizing the spline object arrangement system to distribute and align design objects along vector splines within digital design documents in accordance with one or more embodiments. Specifically, FIG. 9 includes a first digital design 902 comprising multiple design objects resembling leaves distributed along a portion of a curve-linear trajectory (e.g., a vector spline). Also, FIG. 9 includes a second digital design 904 portraying multiple necklaces, including multiple curved paths with design objects portraying various beads distributed thereon. In addition, FIG. 9 includes a third digital design 906 portraying two strands of holiday lights with multiple design objects portraying light bulbs distributed along two separate vector splines.

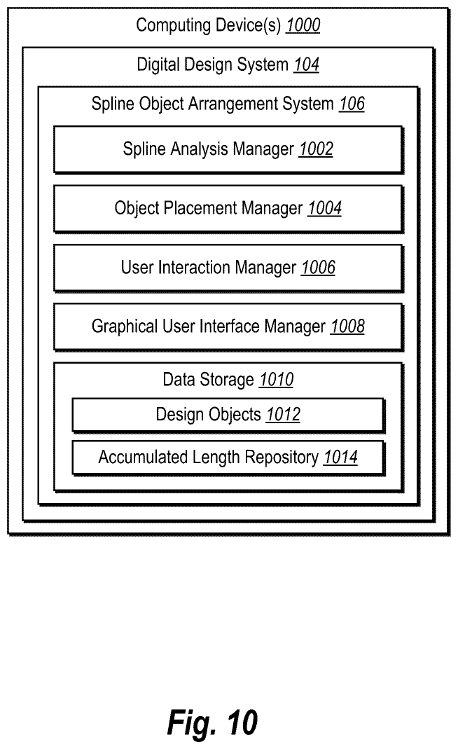

Looking now to FIG. 10, additional detail will be provided regarding components and capabilities of the spline object arrangement system 106. Specifically, FIG. 10 illustrates an example schematic diagram of the spline object arrangement system 106 (e.g., within the digital design system 104) on an example computing device 1000 (e.g., one or more of the client device 110 and/or the server device(s) 102). In some embodiments, the computing device(s) 1000 refers to a distributed computing system where different managers are located on different devices, as described above. As shown in FIG. 10, the spline object arrangement system 106 includes a spline analysis manager 1002, an object placement manager 1004, a user interaction manager 1006, a graphical user interface manager 1008, and a data storage 1010.

As just mentioned, the spline object arrangement system 106 includes the spline analysis manager 1002. In particular, the spline analysis manager 1002 receives, identifies, generates, and/or analyzes vector splines and curve segments thereof to determine accumulated lengths and fractional lengths of curve segments. In some embodiments, the spline analysis manager 1002 generates an accumulated length repository 1014 (e.g., cached within the data storage 1010) comprising the accumulated lengths of the curve segments and/or various positions along the curve segments of a vector spline. Moreover, in some embodiments, the spline analysis manager generates an accumulated length repository comprising a mapping between vector curve position parameters of curve segments along a vector spline and accumulated lengths corresponding to the vector curve position parameters on the curve segments along the vector spline (e.g., at various positions along the curve segments).

As shown in FIG. 10, the spline object arrangement system 106 also includes the object placement manager 1004. In particular, the object placement manager 1004 manages, maintains, determines, identifies, or generates placement positions for distributing design objects along a vector spline according to one or more embodiments. For example, the object placement manager 1004 searches an accumulated length repository to identify selected curve segments and determine placement locations for distributing design objects along a vector spline. In some cases, the object placement manager 1004 also positions the design objects along a vector spline at generated placement positions and aligns the design objects according to user preferences or inputs.

As shown in FIG. 10, the spline object arrangement system 106 also includes the user interaction manager 1006. In particular, the user interaction manager 1006 manages, maintains, detects, determines, or identifies user interactions for distributing and aligning design objects along a vector spline. For example, the user interaction manager 1006 receives various user interactions with a digital design document for implementing one or more of the features described herein, such one or more of creation and/or selection of a vector spline, creation and/or selection of a set of design objects, selection of initial and/or final placement positions for distributing the set of design objects along the vector spline, or interactions for modifying an anchor point, a pivot point, and/or a relative angle of the design objects relative to the vector spline.

As shown in FIG. 10, the spline object arrangement system 106 also includes the graphical user interface manager 1008. In particular, the graphical user interface manager 1008 manages, maintains, extrapolates, determines, detects, or generates a graphical user interface for interacting with a digital design document comprising at least one vector spline and a plurality of design objects. For example, the graphical user interface manager 1008 provides various features for selecting placement positions on a vector spline, adjusting a uniform distance between design objects distributed along a vector spline, modifying an initial object angle of the design objects, and so forth.

As further illustrated in FIG. 10, the spline object arrangement system 106 includes the data storage 1010. The data storage 1010 operates in conjunction with, or includes the spline analysis manager 1002, the object placement manager 1004, the user interaction manager 1006, and the graphical user interface manager 1008. As shown in FIG. 10, the data storage 1010 includes design objects 1012 and the accumulated length repository 1014, accessible and usable by other components of the spline object arrangement system 106. In some cases, the data storage 1010 also stores one or more vector splines, additional design objects, and additional features of the spline object arrangement system 106. In some cases, the data storage 1010 communicates with the other components of the spline object arrangement system 106 to facilitate the operations and functions described herein.

In one or more embodiments, the components of the spline object arrangement system 106 are in communication with one another using any suitable communication technologies. Additionally, the components of the spline object arrangement system 106 are in communication with one or more other devices including one or more client devices described above. It will be recognized that although the components of the spline object arrangement system 106 are shown to be separate in FIG. 10, any of the subcomponents may be combined into fewer components, such as into a single component, or divided into more components as may serve a particular implementation. Furthermore, although the components of FIG. 10 are described in connection with the spline object arrangement system 106, at least some of the components for performing operations in conjunction with the spline object arrangement system 106 described herein may be implemented on other devices within the environment.

The components of the spline object arrangement system 106, in one or more implementations, includes software, hardware, or both. For example, the components of the spline object arrangement system 106 include one or more instructions stored on a computer-readable storage medium and executable by processors of one or more computing devices (e.g., the computing device(s) 1000). When executed by the one or more processors, the computer-executable instructions of the spline object arrangement system 106 cause the computing device(s) 1000 to perform the methods described herein. Alternatively, the components of the spline object arrangement system 106 comprises hardware, such as a special purpose processing device to perform a certain function or group of functions. Additionally, or alternatively, the components of the spline object arrangement system 106 includes a combination of computer-executable instructions and hardware.

Furthermore, the components of the spline object arrangement system 106 performing the functions described herein may, for example, be implemented as part of a stand-alone application, as a module of an application, as a plug-in for applications including content management applications, as a library function or functions that may be called by other applications, and/or as a cloud-computing model. Thus, the components of the spline object arrangement system 106 may be implemented as part of a stand-alone application on a personal computing device or a mobile device. Alternatively, or additionally, the components of the spline object arrangement system 106 may be implemented in any application that allows creation and delivery of marketing content to users, including, but not limited to, applications in ADOBE® CREATIVE CLOUD®, such as ADOBE® PHOTOSHOP®, ILLUSTRATOR®, INDESIGN®, and XDR. “ADOBE,” “CREATIVE CLOUD,” “PHOTOSHOP,” “ILLUSTRATOR,” “INDESIGN,” and “XD” are either registered trademarks or trademarks of Adobe Inc. in the United States and/or other countries.

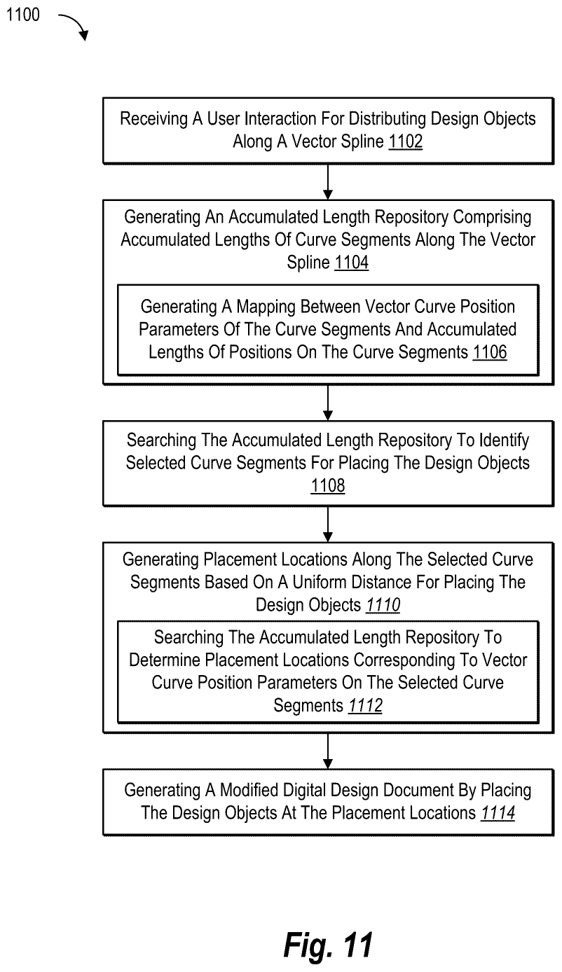

FIGS. 1-10, the corresponding text, and the examples provide a number of different systems, methods, and non-transitory computer readable media for distributing and aligning design objects along a vector spline within a digital design document. In addition to the foregoing, embodiments are describable in terms of flowcharts comprising acts for accomplishing a particular result. For example, FIG. 11 illustrates a flowchart of example sequences or series of acts in accordance with one or more embodiments.

While FIG. 11 illustrate acts according to particular embodiments, alternative embodiments may omit, add to, recorder, and/or modify any of the acts shown in FIG. 11. The acts of FIG. 11 are sometimes performed as part of a computer-implemented method. Alternatively, a non-transitory computer readable medium comprises instructions that, when executed by one or more processors, cause a computing device to perform the acts of FIG. 11. In still further embodiments, a system performs the acts of FIG. 11. Additionally, the acts described herein may be repeated or performed in parallel with one another or in parallel with different instances of the same or other similar acts.

FIG. 11 illustrates a flowchart of a series of acts 1100 for generating a modified digital design document with a plurality of design object distributed along a vector spline. In particular, the series of acts 1100 includes an act 1102 of receiving a user interaction for distributing design objects along a vector spline, an act 1104 of generating an accumulated length repository comprising accumulated lengths of curve segments along the vector spline, an act 1108 of searching the accumulated length repository to identify selected curve segments for placing the design objects, an act 1110 of generating placement locations along the selected curve segments based on a uniform distance for placing the design objects, and an act 1114 of generating a modified digital design document by placing the design objects at the placement location.

As also shown in FIG. 11, in some embodiments, the act 1104 includes an act 1106 of generating a mapping between vector curve position parameters of the curve segments and accumulated lengths of positions on the curve segments and an act 1112. As also illustrated in FIG. 11, in some embodiments, the act 1110 includes an act 1112 of searching the accumulated length repository to determine placement locations corresponding to vector curve position parameters on the selected curve segments.

In particular, in one or more embodiments, the series of acts 1100 includes receiving, via a digital design document, a user interaction for distributing a plurality of design objects along a vector spline comprising a plurality of curve segments, generating, for the plurality of curve segments, an accumulated length repository comprising accumulated lengths of the plurality of curve segments along the vector spline, searching, based on a uniform distance for placing the plurality of design objects, the accumulated length repository to identify selected curve segments from the plurality of curve segments for placing the plurality of design objects, generating a plurality of placement locations along the selected curve segments based on the uniform distance, and generating a modified digital design document by placing the plurality of design objects at the plurality of placement locations.

Also, in some embodiments, generating the accumulated length repository comprises generating the accumulated lengths based on parametric control points of the plurality of curve segments. In one or more embodiments, generating the accumulated length repository comprises determining the accumulated lengths of the plurality of curve segments by iteratively splitting the plurality of curve segments until satisfying a measurement tolerance. In some embodiments, generating the plurality of placement locations along the selected curve segments comprises iteratively splitting the selected curve segments until satisfying a threshold convergence.

Moreover, in one or more embodiments, the series of acts 1100 further includes generating the accumulated length repository, including a mapping between vector curve position parameters of the plurality of curve segments and the accumulated lengths of the plurality of curve segments along the vector spline. In some embodiments, the series of acts 1100 also includes receiving a selected anchor point indicating a relative coordinate within the plurality of design objects for positioning the plurality of design objects on the vector spline and positioning the plurality of design objects with the selected anchor point at the plurality of placement locations. Furthermore, in some embodiments, the series of acts 1100 further includes positioning the plurality of design objects with the selected anchor point at the plurality of placement locations. Also, in some embodiments, the series of acts 1100 includes rotating the plurality of design objects relative to a selected pivot point in response to receiving a user interaction indicating a modification to the initial object angle.

In particular, in one or more embodiments, the series of acts 1100 includes generating, for a vector spline comprising a plurality of curve segments within a digital design document, an accumulated length repository comprising a mapping between vector curve position parameters of the plurality of curve segments and accumulated lengths corresponding to the vector curve position parameters on the plurality of curve segments along the vector spline. Also, in one or more embodiments, the series of acts 1100 includes determining a fractional length for placing a design object on the vector spline, searching the accumulated length repository to identify a selected curve segment from the plurality of curve segments and determine a placement location corresponding to a vector curve position parameter on the selected curve segment by comparing the fractional length with the accumulated lengths indicated within the accumulated length repository, and generating a modified digital design document by placing the design object at the placement location on the selected curve segment. Also, in some embodiments, the series of acts 1100 includes determining the fractional length based on a uniform distance for placing a plurality of design objects along the vector spline.

Moreover, in some embodiments, generating the accumulated length repository includes determining a number of measure locations along a given curve segment of the plurality of curve segments based on a measure of flatness for the given curve segment, determining distances along the given curve segment for the number of measure locations based on a respective number of vector curve position parameters of the given curve segment, and generating, based on the distances, respective accumulated lengths for the given curve segment within the accumulated length repository.

Furthermore, in some embodiments, determining the placement location on the selected curve segment includes, in response to determining that a difference between the fractional length and a nearest accumulated length of the selected curve segment indicated within the accumulated length repository satisfies a tolerance value, generating the placement location at the nearest accumulated length utilizing the vector curve position parameter corresponding to the nearest accumulated length on the selected curve segment.

Also, in some embodiments, determining the placement location on the selected curve segment includes in response to determining that the fractional length falls between consecutive accumulated lengths of the selected curve segment indicated within the accumulated length repository, generating the placement location at a midpoint between the consecutive accumulated lengths by determining the vector curve position parameter corresponding to the midpoint based on respective vector curve position parameters corresponding to the consecutive accumulated lengths on the selected curve segment.

In particular, in one or more embodiments, the series of acts 1100 includes determining, based on a length of a vector spline comprising a plurality of curve segments within a digital design document, a uniform distance for distributing a plurality of design objects across the vector spline from an initial placement location to a final placement location and generating, for the plurality of curve segments, an accumulated length repository comprising accumulated lengths of the plurality of curve segments along the vector spline. In addition, in some embodiments, the series of acts 1100 includes searching, based on the uniform distance, the accumulated length repository to identify selected curve segments from the plurality of curve segments for placing the plurality of design objects and generating a modified digital design document by placing the plurality of design objects at placement locations by iteratively splitting the selected curve segments until satisfying a threshold convergence.

Further, in some embodiments, determining the length of the vector spline includes determining the accumulated lengths of the plurality of curve segments from an initial position of the vector spline to a terminal position of the vector spline. Additionally, in some embodiments, generating the length of the vector spline includes determining an accumulated length of an implicit curve segment connecting the terminal position of the vector spline to the initial position of the vector spline.

Moreover, in one or more embodiments, determining the uniform distance for distributing the plurality of design objects across the vector spline includes determining, utilizing the accumulated length repository, respective distances along the length of the vector spline to the initial placement location and the final placement location, generating a fractional length between the initial placement location and the final placement location based on the respective distances, and determining the uniform distance based on the fractional length. In addition, in one or more embodiments, the series of acts 1100 includes updating the fractional length, the uniform distance, and the placement locations in response to receiving a user interaction relocating one or more of the initial placement location or the final placement location along the vector spline.

Also, in some embodiments, the series of acts 1100 includes receiving a custom spacing for distributing the plurality of design objects across the vector spline from the initial placement location and updating the placement locations of the plurality of design objects by searching, based on the custom spacing, the accumulated length repository to identify updated selected curve segments from the plurality of curve segments.

Furthermore, in some embodiments, the series of acts 1100 includes iteratively splitting the selected curve segments to generate intermediate segment lengths, comparing the intermediate segment lengths with respective target lengths determined for the plurality of design objects based on the uniform distance, and repeating iterations until respective differences between the intermediate segment lengths and the respective target lengths satisfy the threshold convergence.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media. Non-transitory computer-readable storage media (devices) includes optical and/or non-optical memory, disks, or caches that store computer data interpretable by one or more processors to execute particular functions as described herein. A “network” is defined as one or more data links that enable the transport of electronic data between computer systems and/or modules and/or other electronic devices. Information is transferred or provided over a network (either hardwired, wireless, or a combination of hardwired or wireless) to a computer to carry program code in the form of computer-executable instructions or data structures and which can be accessed by a general purpose or special purpose computer.

Computer-executable instructions comprise, for example, instructions and data which, when executed at a processor, cause a general-purpose computer, special purpose computer, or special purpose processing device to perform a certain function or group of functions. In some embodiments, computer-executable instructions are executed on a general-purpose computer to turn the general-purpose computer into a special purpose computer-implementing elements of the disclosure. The computer executable instructions may be, for example, binaries, intermediate format instructions such as assembly language, or even source code.

Embodiments of the present disclosure can also be implemented in cloud computing environments. In this description, “cloud computing” is defined as a model for enabling on-demand network access to a shared pool of configurable computing resources. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth.

FIG. 12 illustrates, in block diagram form, an example computing device 1200 (e.g., the computing device(s) 1000, the client device 110, and/or the server device(s) 102) that may be configured to perform one or more of the processes described above. As shown by FIG. 12, the computing device can comprise a processor(s) 1202, memory 1204, a storage device 1206, an I/O interface 1208, and a communication interface 1210.

In particular embodiments, processor(s) 1202 includes hardware for executing instructions, such as those making up a computer program. As an example, and not by way of limitation, to execute instructions, processor(s) 1202 may retrieve (or fetch) the instructions from an internal register, an internal cache, memory 1204, or a storage device 1206 and decode and execute them. The computing device 1200 includes memory 1204, which is coupled to the processor(s) 1202. The memory 1204 may be used for storing data, metadata, and programs for execution by the processor(s). The memory 1204 may include one or more of volatile and non-volatile memories. The memory 1204 may be internal or distributed memory. The computing device 1200 includes a storage device 1206 includes storage for storing data or instructions. As an example, and not by way of limitation, storage device 1206 can comprise a non-transitory storage medium described above. The computing device 1200 also includes one or more input or output (“I/O”) devices/interfaces 1208, which are provided to allow a user to provide input to (such as user strokes), receive output from, and otherwise transfer data to and from the computing device 1200. These I/O devices/interfaces 1208 may include a mouse, keypad or a keyboard, a touch screen, camera, optical scanner, network interface, modem, other known I/O devices or a combination of such I/O devices/interfaces 1208.

The computing device 1200 can further include a communication interface 1210. The communication interface 1210 can include hardware, software, or both. The communication interface 1210 can provide one or more interfaces for communication (such as, for example, packet-based communication) between the computing device and one or more other computing devices (e.g., computing device 1200) or one or more networks. The computing device 1200 can further include a bus 1212. The bus 1212 can comprise hardware, software, or both that couples components of computing device 1200 to each other.

In the foregoing specification, the invention has been described with reference to specific example embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel to one another or in parallel to different instances of the same or similar steps/acts. The scope of the invention is, therefore, indicated by the appended claims rather than by the foregoing description. All changes that come within the meaning and range of equivalency of the claims are to be embraced within their scope.

What is claimed is:

1. A computer-implemented method comprising:
receiving, via a digital design document, a user interaction for distributing a plurality of design objects along a vector spline comprising a plurality of curve segments;
generating, for the plurality of curve segments, an accumulated length repository comprising accumulated lengths of the plurality of curve segments along the vector spline;
searching, based on a uniform distance for placing the plurality of design objects, the accumulated length repository to identify selected curve segments from the plurality of curve segments for placing the plurality of design objects;
generating a plurality of placement locations along the selected curve segments based on the uniform distance; and
generating a modified digital design document by placing the plurality of design objects at the plurality of placement locations.

2. The computer-implemented method of claim 1, wherein generating the accumulated length repository comprises generating the accumulated lengths based on parametric control points of the plurality of curve segments.

3. The computer-implemented method of claim 1, wherein generating the accumulated length repository comprises determining the accumulated lengths of the plurality of curve segments by iteratively splitting the plurality of curve segments until satisfying a measurement tolerance.

4. The computer-implemented method of claim 1, wherein generating the plurality of placement locations along the selected curve segments comprises iteratively splitting the selected curve segments until satisfying a threshold convergence.

5. The computer-implemented method of claim 1, further comprising:
generating the accumulated length repository, including a mapping between vector curve position parameters of the plurality of curve segments and the accumulated lengths of the plurality of curve segments along the vector spline.

6. The computer-implemented method of claim 1, further comprising:
receiving a selected anchor point indicating a relative coordinate within the plurality of design objects for positioning the plurality of design objects on the vector spline; and
positioning the plurality of design objects with the selected anchor point at the plurality of placement locations.

7. The computer-implemented method of claim 6, further comprising positioning the plurality of design objects at an initial object angle orthogonal to the vector spline.

8. The computer-implemented method of claim 7, further comprising rotating the plurality of design objects relative to a selected pivot point in response to receiving a user interaction indicating a modification to the initial object angle.

9. A system comprising:
one or more memory devices; and
one or more processors configured to cause the system to:
generate, for a vector spline comprising a plurality of curve segments within a digital design document, an accumulated length repository comprising a mapping between vector curve position parameters of the plurality of curve segments and accumulated lengths corresponding to the vector curve position parameters on the plurality of curve segments along the vector spline;
determine a fractional length for placing a design object on the vector spline;
search the accumulated length repository to identify a selected curve segment from the plurality of curve segments and determine a placement location corresponding to a vector curve position parameter on the selected curve segment by comparing the fractional length with the accumulated lengths indicated within the accumulated length repository; and
generate a modified digital design document by placing the design object at the placement location on the selected curve segment.

10. The system of claim 9, wherein the one or more processors are configured to cause the system to generate the accumulated length repository by:
determining a number of measure locations along a given curve segment of the plurality of curve segments based on a measure of flatness for the given curve segment;
determining distances along the given curve segment for the number of measure locations based on a respective number of vector curve position parameters of the given curve segment; and
generating, based on the distances, respective accumulated lengths for the given curve segment within the accumulated length repository.

11. The system of claim 9, wherein the one or more processors are configured to cause the system to determine the placement location on the selected curve segment by, in response to determining that a difference between the fractional length and a nearest accumulated length of the selected curve segment indicated within the accumulated length repository satisfies a tolerance value, generating the placement location at the nearest accumulated length utilizing the vector curve position parameter corresponding to the nearest accumulated length on the selected curve segment.

12. The system of claim 9, wherein the one or more processors are configured to cause the system to determine the placement location on the selected curve segment by, in response to determining that the fractional length falls between consecutive accumulated lengths of the selected curve segment indicated within the accumulated length repository, generating the placement location at a midpoint between the consecutive accumulated lengths by determining the vector curve position parameter corresponding to the midpoint based on respective vector curve position parameters corresponding to the consecutive accumulated lengths on the selected curve segment.

13. The system of claim 9, wherein the one or more processors are further configured to cause the system to determine the fractional length based on a uniform distance for placing a plurality of design objects along the vector spline.

14. A non-transitory computer readable medium storing executable instructions which, when executed by a processing device, cause the processing device to perform operations comprising:
determining, based on a length of a vector spline comprising a plurality of curve segments within a digital design document, a uniform distance for distributing a plurality of design objects across the vector spline from an initial placement location to a final placement location;
generating, for the plurality of curve segments, an accumulated length repository comprising accumulated lengths of the plurality of curve segments along the vector spline;
searching, based on the uniform distance, the accumulated length repository to identify selected curve segments from the plurality of curve segments for placing the plurality of design objects; and
generating a modified digital design document by placing the plurality of design objects at placement locations by iteratively splitting the selected curve segments until satisfying a threshold convergence.

15. The non-transitory computer readable medium of claim 14, the operations further comprising determining the length of the vector spline by determining the accumulated lengths of the plurality of curve segments from an initial position of the vector spline to a terminal position of the vector spline.

16. The non-transitory computer readable medium of claim 15, wherein generating the length of the vector spline further comprises determining an accumulated length of an implicit curve segment connecting the terminal position of the vector spline to the initial position of the vector spline.

17. The non-transitory computer readable medium of claim 14, wherein determining the uniform distance for distributing the plurality of design objects across the vector spline comprises:
determining, utilizing the accumulated length repository, respective distances along the length of the vector spline to the initial placement location and the final placement location;
generating a fractional length between the initial placement location and the final placement location based on the respective distances; and
determining the uniform distance based on the fractional length.

18. The non-transitory computer readable medium of claim 17, the operations further comprising updating the fractional length, the uniform distance, and the placement locations in response to receiving a user interaction relocating one or more of the initial placement location or the final placement location along the vector spline.

19. The non-transitory computer readable medium of claim 14, the operations further comprising:
receiving a custom spacing for distributing the plurality of design objects across the vector spline from the initial placement location; and
updating the placement locations of the plurality of design objects by searching, based on the custom spacing, the accumulated length repository to identify updated selected curve segments from the plurality of curve segments.

20. The non-transitory computer readable medium of claim 14, the operations further comprising generating the placement locations by:
iteratively splitting the selected curve segments to generate intermediate segment lengths;
comparing the intermediate segment lengths with respective target lengths determined for the plurality of design objects based on the uniform distance; and
repeating iterations until respective differences between the intermediate segment lengths and the respective target lengths satisfy the threshold convergence.
